(19) United States
(12) Patent Application Publication
(10) Pub. No.: US 2024/0200563 A1
(43) Pub. Date: Jun. 20, 2024

(54) DIFFUSER ASSEMBLY, ELECTRIC FAN, AND CLEANING DEVICE

(71) Applicant: GUANGDONG WELLING MOTOR MANUFACTURING CO., LTD., Foshan (CN)

(72) Inventors: Yi JIN, Foshan (CN); Zhuo LV, Foshan (CN); Rong DING, Foshan (CN)

(73) Assignee: GUANGDONG WELLING MOTOR MANUFACTURING CO., LTD., Foshan (CN)

(21) Appl. No.: 18/594,766

(22) Filed: Mar. 4, 2024

Related U.S. Application Data
(63) Continuation of application No. PCT/CN2022/079370, filed on Mar. 4, 2022.

(30) Foreign Application Priority Data
Sep. 6, 2021 (CN) 202111040484.9
Sep. 6, 2021 (CN) 202122146156.9

(51) Int. Cl. F04D 25/08; F04D 29/44; F04D 29/58

(52) U.S. Cl. CPC F04D 25/082; F04D 29/444; F04D 29/5806

(57) ABSTRACT

A diffuser assembly, an electric fan and a cleaning device are provided. The diffuser assembly includes an inner housing, an outer housing and diffusion blades. The outer housing and the inner housing are arranged at an interval. A diffusion channel is formed between the outer housing and the inner housing. The diffusion blades are provided in the diffusion channel and arranged in the circumferential direction of the inner housing. In the axial direction of the inner housing, the tail ends of the diffusion blades protrude out of the tail end of the inner housing.

### CROSS-REFERENCE TO RELATED APPLICATIONS

This application is a continuation of International Application No. PCT/CN2022/079370 filed on Mar. 4, 2022, which claims priority to Chinese Patent Application No. 202111040484.9 filed on Sep. 6, 2021 and Chinese Patent Application No. 202122146156.9 filed on Sep. 6, 2021, the entire contents of each of which are incorporated herein by reference for all purposes. No new matter has been introduced.

### FIELD

The present disclosure relates to the field of electric fans, and in particular to a diffuser assembly, an electric fan, and a cleaning device.

### BACKGROUND

In the related technology, electric fans in handheld vacuum cleaners are typically relatively small in size and high in rotating speed. When the motor of an electric fan drives the impeller to rotate, a high degree of vacuum is formed at the entrance of the fan cover, and airflow is sucked in from the opening of the fan cover, and after obtaining large kinetic energy from the flow channel of the impeller, flows out through the diffuser at the back. Due to the small volume and high power of the electric fan and the fact that airflow of the diffuser does not pass through the motor, the heat dissipation of the motor is not effective.

### SUMMARY

The present disclosure at least alleviates at least one of the related technical problems existing in the related art. To this end, the present disclosure provides a diffuser assembly, which can guide part of the diffuser airflow to dissipate heat from the motor, thereby improving the heat dissipation efficiency and having less interference to the diffuser airflow.

The present disclosure further provides an electric fan having the diffuser assembly described above.

The present disclosure further provides a cleaning apparatus that includes the electric fan described above.

According to an embodiment of the present disclosure, a diffuser assembly is provided. The diffuser assembly includes an inner shell, an outer shell, and diffusers. The outer shell is spaced from the inner shell. A diffuser channel is formed between the outer shell and the inner shell. The diffuser vanes are provided in the diffuser channel and arranged along a circumferential direction of the inner shell. Along an axial direction of the inner shell, terminal ends of the diffuser vanes extend beyond a terminal end of the inner shell.

The diffuser assembly according to an embodiment of the present disclosure has at least the following beneficial effects.

By providing the diffuser channel formed by the inner shell, the outer shell, and the diffuser vanes, with the terminal ends of the diffuser vanes protruding from the terminal end of the inner shell along the axial direction of the inner shell, part of the airflow of the diffuser channel can be guided into the inner shell, so as to enhance the flow of air around the motor of the inner shell. Thus, heat dissipation of the motor can be accelerated and the temperature of the motor can be lowered. In addition, diverting part of the diffuser airflow at the air outlet end of the diffuser channel for heat dissipation of the motor only exerts a minor influence on the diffusion effect, which in turn enhances the heat dissipation of the motor while ensuring the diffusion performance of the diffuser assembly.

According to some embodiments of the present disclosure, along the axial direction of the inner shell, the height of the diffuser vanes is h1, and the height from where the inner shell mates with an air inlet end of the diffuser vanes, to the terminal end of the inner shell is h2, the relationship between h1 and the h2 satisfies: 0.4≤h2/h1≤0.8.

According to some embodiments of the present disclosure, the interior of the inner shell is configured for accommodating a stator, and an outer peripheral wall of the stator is spaced from an inner peripheral wall of the inner shell.

According to some embodiments of the present disclosure, the diffuser assembly further includes mounting portions for mounting a stator, the mounting portions are provided at the terminal ends of the diffuser vanes along the axial direction of the inner shell.

According to some embodiments of the present disclosure, the diffuser vanes include a plurality of first vanes and a plurality of second vanes, along the axial direction of the inner shell, the first vanes are connected to the mounting portions in a smoothly transitional manner, and the second vanes are provided between adjacent ones of the first vanes.

According to some embodiments of the present disclosure, the first vanes are integrally molded with the mounting portions.

According to some embodiments of the present disclosure, six first vanes as described above are provided, the first vanes and the second vanes are evenly distributed along the circumferential direction of the inner shell.

According to some embodiments of the present disclosure, the mounting portions are screw holes, and the stator is fixedly connected to the mounting portions by means of screws. According to another embodiment of the present disclosure, a diffuser assembly is provided. The diffuser assembly includes an inner shell, an outer shell and diffuser vanes. The inner shell forms therein an accommodating cavity for accommodating a stator. The outer shell is spaced from the inner shell, with a diffuser channel being formed between the outer shell and the inner shell. The diffuser vanes are provided in the diffuser channel and arranged along a circumferential direction of the inner shell. The inner shell is provided with a notch groove at a terminal end along the axial direction, and the notch groove communicates the diffuser channel and the accommodating cavity.

The diffuser assembly according to the embodiment of the present disclosure has at least the following beneficial effects.

By providing the diffuser channel formed by the inner shell, the outer shell, and the diffuser vanes, and the inner shell provided at a terminal end along the axial direction with a notch groove that communicates with the accommodating cavity for accommodating the stator, part of the airflow of the diffuser channel can be guided into the accommodating cavity, so as to enhance the flow of air around the stator. Thus, heat dissipation of the motor can be accelerated and the temperature of the motor can be lowered. Therefore, the reliability and work efficiency of the electric fan can be improved. In addition, providing the notch groove at the air outlet end of the diffuser channel to divert part of the diffuser airflow for heat dissipation of the motor only exerts a minor influence on the diffusion effect, which in turn enhances the heat dissipation of the motor while ensuring the diffusion performance of the diffuser assembly.

According to some embodiments of the present disclosure, terminal ends of the diffuser vanes extend beyond a bottom wall of the notch groove.

According to yet another embodiment of the present disclosure, an electric fan is provided, which includes a diffuser assembly described in the above embodiment.

The electric fan according to the embodiment of the present disclosure has at least the following beneficial effects.

By adopting the diffuser assembly of the above embodiment, the diffuser channel is formed by the inner shell, the outer shell, and the diffuser vanes, with the terminal ends of the diffuser vanes protruding from the terminal end of the inner shell along the axial direction of the inner shell, the diffuser assembly can guide part of the airflow of the diffuser channel into the inner shell, so as to enhance the flow of air around the motor of the inner shell. Thus, heat dissipation of the motor can be accelerated and the temperature of the motor can be lowered. Therefore, the reliability and work efficiency of the electric fan can be improved. In addition, diverting part of the diffuser airflow at the air outlet end of the diffuser channel for heat dissipation of the motor only exerts a minor influence on the diffusion effect, which thus enhances the heat dissipation of the motor while ensuring the diffusion performance of the diffuser assembly.

According to yet another embodiment of the present disclosure, a cleaning apparatus is provided, which includes an electric fan as described in the above embodiment.

The cleaning apparatus according to the embodiment of the present disclosure has at least the following beneficial effects.

The electric fan of the embodiment described above is adopted, where the electric fan includes a diffuser assembly, and by providing the diffuser channel formed by the inner shell, the outer shell, and the diffuser vanes, with the terminal ends of the diffuser vanes protruding from the terminal end of the inner shell along the axial direction of the inner shell, the diffuser assembly can guide part of the airflow of the diffuser channel into the inner shell, so as to enhance the flow of air around the motor of the inner shell. Thus, heat dissipation of the motor can be accelerated and the temperature of the motor can be lowered. Therefore, the reliability and work efficiency of the electric fan can be improved. In addition, diverting part of the diffuser airflow at the air outlet end of the diffuser channel for heat dissipation of the motor only exerts a minor influence on the diffusion effect, which in turn enhances the heat dissipation of the motor while ensuring the diffusion performance of the diffuser assembly.

Additional aspects and advantages of the present disclosure will be given, in part, in the following description, in part as will become apparent from the following description, or as will be learned through the practice of the present disclosure.

### BRIEF DESCRIPTION OF DRAWINGS

The present disclosure will be further illustrated with reference to the accompanying drawings and embodiments. In the accompanying drawings:

FIG. 1 is a cross-sectional schematic diagram of an electric fan of an embodiment of the present disclosure;

FIG. 2 is an exploded schematic diagram of an electric fan of an embodiment of the present disclosure;

FIG. 3 is an exploded diagram of a stationary impeller and an enclosure assembly of an embodiment of the present disclosure;

FIG. 4 is a schematic diagram of the enclosure assembly of FIG. 3;

FIG. 5 is a cross-sectional schematic diagram of FIG. 4;

FIG. 6 is a bottom view of FIG. 4;

FIG. 7 is a relationship diagram of h1/h2 versus a winding temperature and a fan efficiency in an electric fan of an embodiment of the present disclosure;

FIG. 8 is a schematic diagram of an enclosure assembly of another embodiment of the present disclosure;

FIG. 9 is a schematic diagram of an enclosure assembly of another embodiment of the present disclosure, with an outer shell removed;

FIG. 10A is a schematic diagram of airflow of a first vane of FIG. 9; and

FIG. 10B is a schematic diagram of airflow of a rib in the prior art.

### LIST OF REFERENCE NUMERALS

electric fan 1000;
fan cover 100;
movable impeller 200;
enclosure 300;
   inner shell 310;
   accommodating cavity 311;
   outer shell 320;
   secondary diffuser vane 330;
   mounting hub 340;
   mounting position 341;
   connecting arm 350;
   rib 360;
   first vane 370;
   main body portion 371;
   thickened portion 372;
   second vane 380;
stationary impeller 400;
   supporting base 410;
   primary diffuser vane 420;
motor 500;
   stator 510;
   rotor 520;
   rotating shaft 530;
circuit substrate 600.

### DETAILED DESCRIPTION OF EMBODIMENTS

Embodiments of the present disclosure are described in detail below, and examples of the embodiments are shown in the accompanying drawings, throughout this document, the same or similar labels denote the same or similar elements or elements having the same or similar functions. The embodiments described below by referring to the drawings are illustrative, only for explaining the present disclosure, and are not intended to be understood as a limitation of the present disclosure.

In the description of the present disclosure, it is to be understood that descriptions involving orientation, such as the orientation or positional relationship indicated by up, down, or the like, are based on the orientation or positional relationship shown in the accompanying drawings, and are intended solely to facilitate the description of the present disclosure and to simplify the description, and are not indicative of, or suggestive of, that the apparatus or element referred to must have a particular orientation or be constructed and operated with a particular orientation, and therefore are not to be construed as limitations on the present disclosure.

In the description of the present disclosure, a plurality refers to more than two. If “first” and “second”, etc. are referred to, it is only for the purpose of distinguishing technical features, and shall not be construed as indicating or implying relative importance or implying the number of the indicated technical features or implying the sequence of the indicated technical features.

In the description of the present disclosure, unless otherwise explicitly defined, the words such as setting, mounting and connection should be understood in a broad sense, and those skilled in the technical field can reasonably determine the specific meanings of the above words in the present disclosure in combination with the specific contents of the technical scheme.

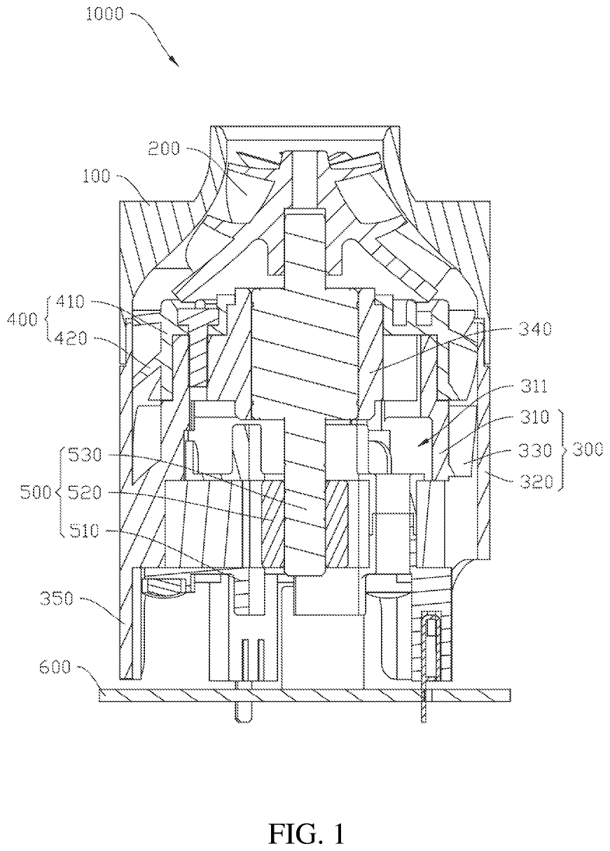

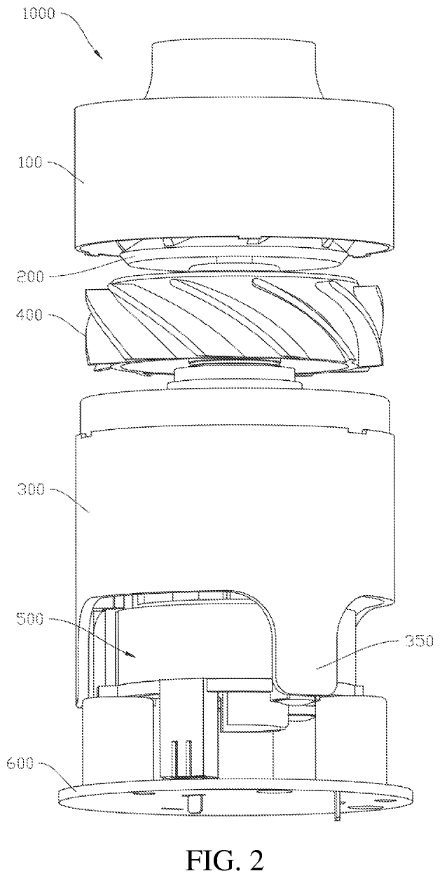

Referring to FIGS. 1 and 2, according to an embodiment of the present disclosure, the electric fan 1000 can be used in a cleaning device (such as, a vacuum cleaner), and in particular can be used in a portable device (such as, a handheld vacuum cleaner or a sweeper robot) which requires a small size. According to an embodiment of the present disclosure, the electric fan 1000 includes a fan cover 100, a movable impeller 200, an enclosure 300, a stationary impeller 400, and a motor 500. An end of the fan cover 100 is provided with an air inlet (not shown), and the other end of the fan cover 100 is connected to the enclosure 300. The movable impeller 200 is arranged in the fan cover 100. The fan cover 100 is wrapped on the radial outer side of the movable impeller 200 and forms an air inlet channel with the fan cover 100.

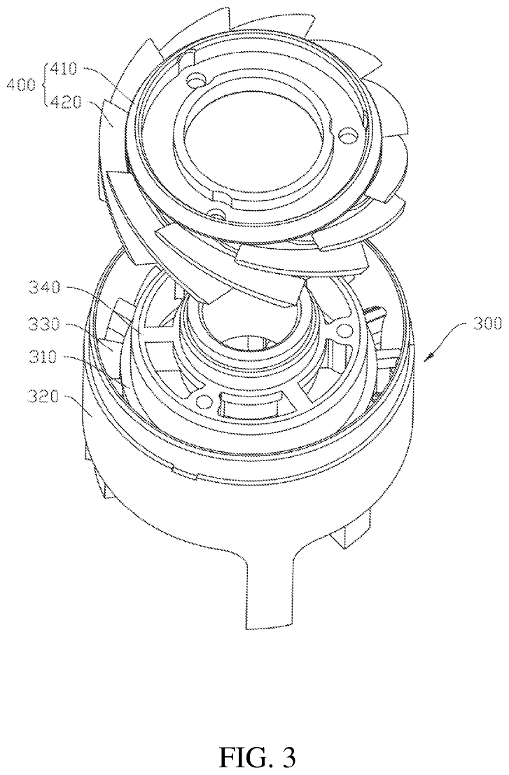

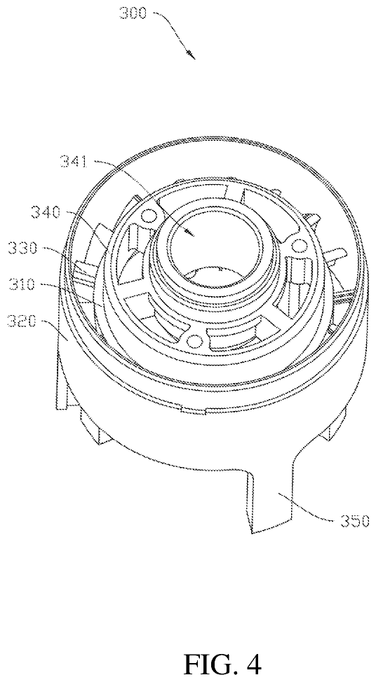

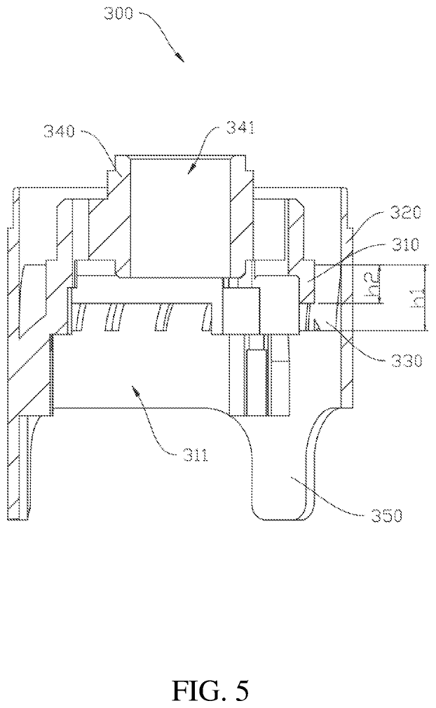

Referring to FIG. 3, according to an embodiment of the present disclosure, the diffuser assembly includes an enclosure 300 and a stationary impeller 400. The enclosure 300 and the stationary impeller 400 form a diffuser channel communicated with the air outlet end of the air inlet channel. The diffuser channel converts the kinetic energy of the airflow into air pressure energy to realize deceleration and pressurization of the airflow, thereby improving the efficiency of the electric fan 1000. Referring to FIGS. 4 and 5, according to an embodiment of the present disclosure, the enclosure 300 includes an inner shell 310, an outer shell 320, and secondary diffuser vanes 330 located between the inner shell 310 and the outer shell 320. The inner shell 310 and the outer shell 320 are spaced apart, with a second diffuser channel being formed between the inner shell 310 and the outer shell 320. The secondary diffuser vanes 330 are distributed on the circumference of the inner shell 310.

Referring to FIGS. 3 and 4, the enclosure 300 further includes a mounting hub 340. The mounting hub 340 is fixedly connected to the inner shell 310 and the mounting hub 340 is located at an end of the inner shell 310 that faces the stationary impeller 400. The stationary impeller 400 includes a supporting base 410 and primary diffuser vanes 420 connected to the outer periphery of the supporting base 410. The supporting base 410 is mounted onto the mounting hub 340. A first diffuser channel is formed between the supporting base 410, the primary diffuser vanes 420, and the outer shell 320. The first diffuser channel is located between the second diffuser channel and the air inlet channel. The first diffuser channel and the second diffuser channel form the diffuser channels of the electric fan 1000.

Referring to FIGS. 1 and 5, it can be understood that the inner shell 310 forms internally an accommodating cavity 311. The accommodating cavity 311 is configured to accommodate a motor 500. The motor 500 includes a stator 510, a rotor 520, and a rotating shaft 530. The stator 510 is fixed in the accommodating cavity 311. The rotor 520 is mounted on the rotating shaft 530. The rotating shaft 530 is mounted into a mounting position 341 of the mounting hub 340 through bearings, with an end of the rotating shaft 530 being connected to the movable impeller 200 to drive the movable impeller 200 to rotate. Thus, the airflow obtains kinetic energy from the movable impeller 200, passes through the first diffuser channel and goes into the second diffuser channel, and finally flows out of the electric fan 1000.

Referring to FIG. 2, according to an embodiment of the present disclosure, the electric fan 1000 further includes a circuit substrate 600. The circuit substrate 600 is fixedly connected to the enclosure 300, and is located at a tail end of the motor 500, i.e., an end distal to the movable impeller 200. The enclosure 300 can be provided with a connecting arm 350 that extends away from the fan cover 100. The connecting arm 350 may be connected and integrated with the outer shell 320 as a piece such that the structural strength of the connecting arm 350 is improved. Moreover, the connecting arm 350 is provided on the outer shell 320 so that it is not easy to interfere with the stator 510, thereby improving the convenience of mounting the stator 510 to the enclosure 300. In an embodiment, three connecting arms 350 are provided and the three connecting arms 350 are spaced apart along the circumferential direction of the outer shell 320. The circuit substrate 600 is fixedly connected to the three connecting arms 350 by means of screwing, thereby achieving stable mounting of the circuit substrate 600.

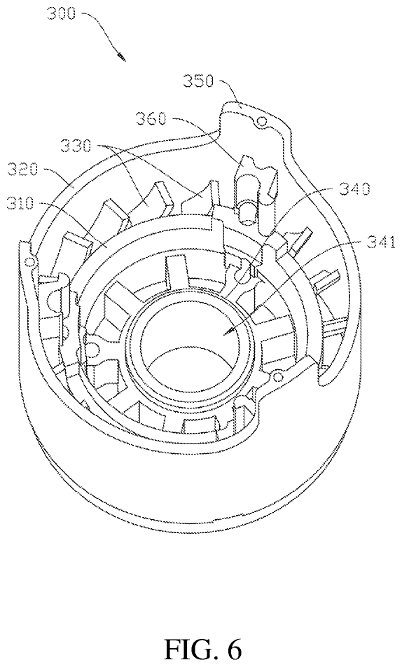

Referring to FIG. 6, it can be understood that along the airflow direction of the second diffuser channel, terminal ends of the secondary diffuser vanes 330 along the axial direction of the inner shell 310 extend beyond a terminal end of the inner shell 310. As such, it is possible to guide a part of the airflow of the diffuser channel to the accommodating cavity 311 to enhance the flow of air around the motor 500 in the inner shell 310, thereby accelerating heat dissipation of the motor 500 and lowering the temperature of the motor 500. Thus, the reliability of the electric fan 1000 can be improved and the work efficiency of the electric fan 1000 can be improved. In addition, in an embodiment of the present disclosure, diverting a part of the diffuser airflow at the air outlet end of the second diffuser channel for heat dissipation of the motor 500 has a minor influence on the diffusion effect of the diffuser assembly, which thus enhances the heat dissipation of the motor 500 while ensuring the diffusion performance of the diffuser assembly. Therefore, the performance of the electric fan 1000 can be improved.

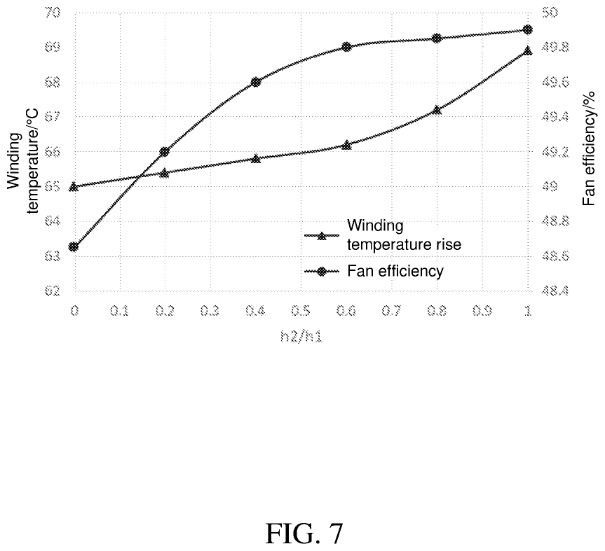

Referring to FIGS. 6 and 7, according to an embodiment of the present disclosure, in the enclosure 300, the height of the secondary diffuser vanes 330 along the axial direction of the inner shell 310 is defined as h1, and the height from where the inner shell 310 mates with the air inlet end of the secondary diffuser vanes 330, to the terminal end of the inner shell 310, along the axial direction is defined as h2. A relationship equation is satisfied between the height h1 of the secondary diffuser vanes 330 and the height h2 of the inner shell 310: 0.4≤h2/h1≤0.8. As can be seen from FIG. 7, when the parameter h2/h1 is within the range of 0.4 to 0.8, the efficiency of the electric fan 1000 is high, and the temperature rise of windings of the motor 500 is low, in such a case, the influence on the diffusion effect of the diffuser assembly is minor, which thus enhances the heat dissipation of the motor 500 while ensuring the diffusion performance of the diffuser assembly. Thus, the reliability of the motor 500 can be improved and the performance of the electric fan 1000 can be improved. However, when the parameter h2/h1 is lower than 0.4, the temperature rise of the windings of the motor 500 decreases slightly, but the efficiency of the electric fan 1000 decreases significantly. When h2/h1 is higher than 0.8, the efficiency of the electric fan 1000 increases slightly, but the rising of the temperature of the windings of the motor 500 is high and the cooling effect is poor.

It can be understood that, in order to further improve the diffusion effect of the electric fan 1000 and to reduce the impact loss, the inlet side of the secondary diffuser vanes 330 and the outlet side of the primary diffuser vanes 420 have the same orientation and the included angle between the directions of the tangent line of the inlet side of the primary diffuser vanes 420 and the tangent line of the outlet side of the secondary diffuser vanes 330 is set to be less than 10 degrees, thereby enabling the matching with the flow direction of the diffuser airflow, so as to improve the diffusion effect.

With reference to FIGS. 1 and 5, it can be understood that an accommodating cavity 311, which is configured to accommodate the stator 510, is provided in the interior of the inner shell 310. Moreover, the arrangement that the stator 510 is spaced from the inner shell 310, can be understood as that the outer peripheral wall of the stator 510 is in a clearance fit with the inner peripheral wall of the inner shell 310, or as that part of the outer peripheral wall of the stator 510 is in a clearance fit with part of the inner peripheral wall of the inner shell 310, thereby forming a clearance. Such an arrangement further accelerates the flow of airflow around the motor 500, accelerates heat dissipation of the motor 500, and lowers the temperature of the motor 500, thereby further improving the reliability of the electric fan 1000 and improving the work efficiency of the electric fan 1000.

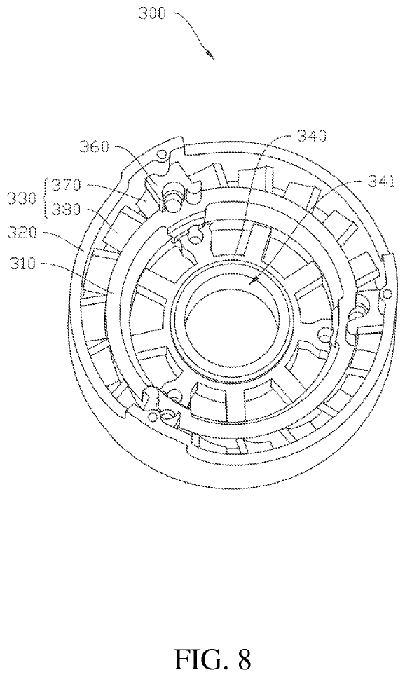

Referring to FIG. 8, it can be seen that the enclosure 300 is provided with several ribs 360 configured to be secured to a mounting bracket (not shown in the figure) of the stator 510. In an embodiment, the ribs 360 are provided with screw holes or the like, so as to realize stable mounting with the stator 510. The ribs 360 are provided at the terminal end of the inner shell 310 along the flow direction of the diffuser airflow, or may also be provided at the terminal end of the outer shell 320 along the flow direction of the diffuser airflow. Along the axial direction of the inner shell 310, each rib 360 is connected to the terminal end of a secondary diffuser vane 330, which can reduce the area of blockage of the diffuser airflow by the ribs 360, thereby reducing the blockage of the diffuser channel by the ribs 360, thus reducing the flow loss in the diffuser channel and improving the efficiency of the electric fan 1000. It is to be noted that the ribs 360 may also be other forms of mounting portions and will not be specifically limited herein.

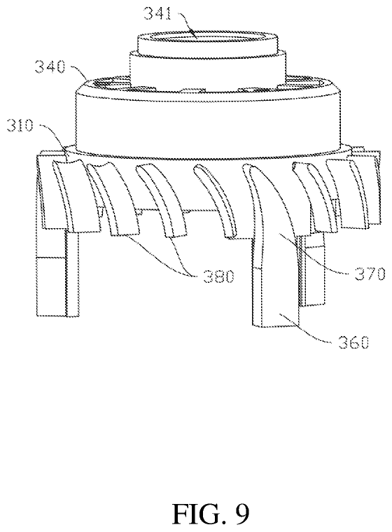

Referring to FIG. 9, it can be understood that the enclosure 300 includes a plurality of first vanes 370 and a plurality of second vanes 380. The first vanes 370 and the second vanes 380 are both provided within the second diffuser channel and arranged along the circumferential direction of the inner shell 310. Along the direction of the diffuser airflow, the thickness of the terminal ends of the first vanes 370 is greater than the thickness of the terminal ends of the second vanes 380. The second vanes 380 are normal secondary diffuser vanes 330. The first vanes 370 are a structure designed for the secondary diffuser vanes 330 to adapt to the structure of the ribs 360, or vane structures easily integrated with the ribs 360. It can be understood that the first vanes 370 can be a structure with a thickness that gradually increases in the direction of the diffuser airflow. Embodiments of the present disclosure can integrate the ribs 360, which would block the diffuser channel in a conventional structure, with the first vanes 370, thereby further reducing the blockage of the diffuser airflow by the ribs 360, and significantly reducing the blockage of the diffuser airflow. Thus, the efficiency of the electric fan 1000 can be improved. At the same time, the secondary diffuser vanes 330 utilize the positions of the ribs 360 and the ribs 360 are integrated with the secondary diffuser vanes 330, thus saving the space of the electric fan 1000 and eliminating the need to provide additional axial mounting space. Therefore, the efficiency of the electric fan 1000 can be improved.

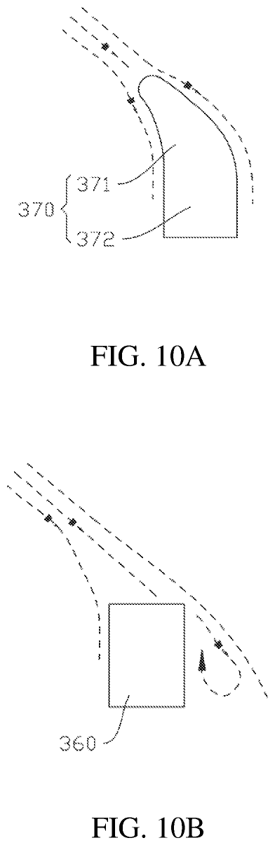

Referring to FIG. 9, it can be understood that along the axial direction of the inner shell 310, a first vane 370 is connected to a rib 360 in a smoothly transitional manner. In order to provide a smooth transition between the rib 360 and the first vane 370, the first vane 370 forms a secondary diffuser vane 330 having a gradually increasing thickness along the airflow direction. Referring to FIGS. 10A and 10B, FIG. 10A is a schematic diagram of airflow of a first vane 370 according to an embodiment of the present disclosure, and FIG. 10B is a schematic diagram of airflow for the blockage of the diffuser channel by a rib 360 in a conventional structure of the prior art. As can be seen from the comparison, the conventional structure will cause backflow of the airflow, thus resulting in energy loss and reducing the efficiency of the electric fan 1000. Upon experimental measurement, the efficiency of the electric fan 1000 using the first vanes 370 is 48%, while the efficiency of the electric fan 1000 without the first vanes 370 in the conventional structure is 46%, which demonstrates that the design of the first vanes 370 in this embodiment can effectively improve the efficiency of the electric fan 1000.

Referring to FIG. 9, it can be understood that the first vanes 370 are integrally molded with the ribs 360, thus allowing for easier machining and higher structural strength. It is to be noted that, for an embodiment of the present disclosure, it can be understood that instead of providing the ribs 360, the first vanes 370 extend to form mounting portions that have the functionality of the ribs 360. By way of example, the first vanes 370 are provided with mounting portions such as screw holes, and the stator 510 is fixedly connected to the mounting portions by means of screws, which facilitates assembly and improves the efficiency of assembly.

FIG. 10A illustrates a first vane 370 according to an embodiment of the present disclosure. The first vane 370 is structured to include a main body portion 371 and a thickened portion 372 in sequence along the direction of the diffuser airflow. The thickened portion 372 is connected to the main body portion 371 at a position of 0.5-0.8 times the chord length of the first vane 370, and an end of the first vane 370 that is distal to the inner shell 310 is an outer edge, with the thickness of the outer edge of the main body portion 371 gradually increasing along the direction of the diffuser airflow at a position that is 0.1-0.3 times the chord length from the first vane 370, so that the thickness of the air inlet end of the first vane 370 is the same as the thickness of the air inlet end of the second vane 380, thereby improving the air inlet efficiency of the diffuser channel, and also ensuring the diffusion effect of the first vane 370 and decreasing the flow loss. The thickness of the outer edge of the thickened portion 372 remains unchanged along the direction of the diffuser airflow, thereby ensuring that the thickened portion 372 can be provided with mounting portions such as screw holes. Thus, the reliability of the mounting of the stator 510 can be ensured.

Referring to FIG. 9, it can be understood that a plurality of second vanes 380 are provided. The plurality of second vanes 380 are provided in an even distribution between adjacent ones of the first vanes 370. A plurality of sections of diffuser channels are formed between the first vanes 370 and the second vanes 380, or between the second vanes 380 and the second vanes 380, thereby ensuring the diffuser effect of the diffuser assembly, and facilitating the effective noise reduction of the diffuser assembly.

In another embodiment, six first vanes 370 and nine second vanes 380 are provided. The terminal ends of the first vanes 370 are all provided with mounting portions, i.e., each of the six mounting portions is used for fixing the stator, thereby making the mounting of the stator more stable. The six first vanes 370 and the nine second vanes 380 are provided in an even distribution along the circumferential direction of the inner shell 310 to ensure the diffuser performance of the diffuser assembly. The arrangement order of the first vanes 370 and the second vanes 380 may have various forms, which will not be specifically limited herein.

It can be understood that the inner shell 310 of the above embodiment can be understood as a structure formed by cutting off a section of the inner shell 310 along the axial direction, so that the terminal ends of the secondary diffuser vanes 330 extend beyond the terminal end of the inner shell 310. It should be noted that in the above embodiment, the machining of the structure can be realized by using integral molding, or the machining can be carried out by using secondary machining to remove part of the inner shell 310, which will not be specifically limited herein.

It can be understood that, according to another embodiment of the present disclosure, the enclosure 300 includes an inner shell 310, an outer shell 320, and secondary diffuser vanes 330.

The enclosure 300 in this embodiment of the present disclosure is substantially the same as the enclosure 300 in any one of the above embodiments, with the difference in that, the inner shell 310 of this embodiment is provided with a notch groove (not shown in the figure) at a terminal end along the axial direction, the notch groove is capable of communicating the diffuser channel and the accommodating cavity 311. It should be noted that the notch groove may also be replaced by a through hole, which will not be specifically limited herein. A plurality of notch grooves may be provided, the plurality of notch grooves are spaced apart along the circumferential direction of the inner shell 310.

The notch grooves are capable of guiding part of the airflow of the diffuser channel from the diffuser channel to the accommodating cavity 311 to enhance the flow of air around the motor 500, thereby accelerating heat dissipation of the motor 500 and lowering the temperature of the motor 500, thus improving the reliability of the electric fan 1000 and improving the work efficiency of the electric fan 1000. Moreover, providing the notch grooves at the terminal end of the inner shell 310 along the diffuser airflow to realize diversion of part of the diffuser airflow for heat dissipation of the motor 500, only exerts a minor influence on the diffusion effect of the diffuser assembly, which thus enhances the heat dissipation of the motor 500 while ensuring the diffusion performance of the diffuser assembly, thereby improving the performance of the electric fan 1000.

It can be understood that along the axial direction of the inner shell 310, the terminal ends of the secondary diffuser vanes 330 extend beyond the bottom walls of the notch grooves, so that the diffuser airflow can be further smoothly guided from the secondary diffuser vanes 330 to the surface of the motor 500, so as to further enhance heat dissipation of the motor 500, thereby further improving the reliability and performance of the electric fan 1000.

Referring to FIG. 1, according to an embodiment of the present disclosure, an electric fan 1000 is provided, which includes the diffuser assembly of any one of the above embodiments. The electric fan 1000 adopts the diffuser assembly of any one of the above embodiments. In the diffuser assembly, a diffuser channel is formed by the inner shell 310, the outer shell 320, and the secondary diffuser vanes 330, with the terminal ends of the secondary diffuser vanes 330 protruding from the terminal end of the inner shell 310 along the axial direction of the inner shell 310. Thus, part of the airflow of the diffuser channel can be guided into the internal of the inner shell 310, so as to enhance the flow of air in the vicinity of the motor 500 of the inner shell 310. Thus, heat dissipation of the motor 500 can be accelerated and the temperature of the motor 500 can be lowered. Therefore, the reliability and work efficiency of the electric fan 1000 can be improved. In addition, diverting part of the diffuser airflow at the air outlet end of the diffuser channel for heat dissipation of the motor 500 only exerts a minor influence on the diffusion effect, which in turn enhances the heat dissipation of the motor 500 while ensuring the diffusion performance of the diffuser assembly.

By employing all of the technical schemes of the diffuser assembly of any one of the above embodiments, the electric fan 1000 has at least all of the beneficial effects of the technical schemes of any one of the above embodiments, which will not be repeated here.

According to an embodiment of the present disclosure, a cleaning apparatus is provided, which includes the electric fan 1000 of any one of the above embodiments. The cleaning apparatus adopts the electric fan 1000 of the above embodiment. The electric fan 1000 includes a diffuser assembly. In the diffuser assembly, a diffuser channel is formed by the inner shell 310, the outer shell 320, and the secondary diffuser vanes 330, with the terminal ends of the secondary diffuser vanes 330 protruding from the terminal end of the inner shell 310 along the axial direction of the inner shell 310. As such, part of the airflow of the diffuser channel can be guided into the inner shell 310, so as to enhance the flow of air around the motor 500 of the inner shell 310, thereby accelerating heat dissipation of the motor 500 and lowering the temperature of the motor 500. Thus, the reliability and work efficiency of the electric fan 1000 can be improved. In addition, diverting part of the diffuser airflow at the air outlet end of the diffuser channel for heat dissipation of the motor 500 only exerts a minor influence on the diffusion effect, which in turn enhances the heat dissipation of the motor 500 while ensuring the diffusion performance of the diffuser assembly.

By employing all of the technical schemes of the diffuser assembly in any one of the above embodiments, the cleaning apparatus has at least all of the beneficial effects of the technical schemes of the above embodiments, which will not be repeated herein.

Although the embodiments of the present disclosure have been described in detail above with reference to the accompanying drawings, the present disclosure is not limited to the above embodiments, and various changes may be made within the knowledge of those of ordinary skill in the art without departing from the purpose of the present disclosure.

1. A diffuser assembly comprising:
an inner shell;
an outer shell spaced from the inner shell, a diffuser channel being formed between the outer shell and the inner shell; and
a plurality of diffuser vanes provided in the diffuser channel and arranged along a circumferential direction of the inner shell,
wherein along an axial direction of the inner shell, a terminal end of each of the diffuser vanes extends beyond a terminal end of the inner shell.

2. The diffuser assembly of claim 1, wherein along the axial direction of the inner shell, a height of the diffuser vanes is h1, the height from where the inner shell mates with an air inlet end of the diffuser vanes, to the terminal end of the inner shell is h2, and the h1 and the h2 satisfies: 0.4≤h2/h1≤0.8.

3. The diffuser assembly of claim 1, wherein:
an interior of the inner shell is configured for accommodating a stator; and
an outer peripheral wall of the stator is spaced from an inner peripheral wall of the inner shell.

4. The diffuser assembly of claim 1, wherein:
the diffuser assembly further comprises a plurality of mounting portions for mounting a stator; and
each of the mounting portion is provided at a terminal end of one of the diffuser vanes along the axial direction of the inner shell.

5. The diffuser assembly of claim 4, wherein:
the diffuser vanes comprise a plurality of first vanes and a plurality of second vanes, along the axial direction of the inner shell;
each of the first vanes is connected to a respective one of the mounting portions in a smoothly transitional manner; and
the second vanes are provided between adjacent ones of the first vanes.

6. The diffuser assembly of claim 5, wherein each of the first vanes is integrally molded with a respective one of the mounting portions.

7. The diffuser assembly of claim 5, wherein:
the first vanes are provided in a number of six; and
the first vanes and the second vanes are distributed evenly along the circumferential direction of the inner shell.

8. The diffuser assembly of claim 4, wherein:
the mounting portions are screw holes; and
the stator is fixedly connected to the mounting portions by means of screws.

9. A diffuser assembly comprising:
an inner shell forming an accommodating cavity for accommodating a stator, wherein the accommodating cavity is in the inner shell;
an outer shell spaced from the inner shell, a diffuser channel being formed between the outer shell and the inner shell; and
diffuser vanes provided in the diffuser channel and arranged along a circumferential direction of the inner shell,
wherein the inner shell is provided with a notch groove at a terminal end along an axial direction, and the notch groove communicates the diffuser channel and the accommodating cavity.

10. The diffuser assembly of claim 9, wherein along the axial direction of the inner shell, a terminal end of each of the diffuser vanes extends beyond a bottom wall of the notch groove.

11. An electric fan comprising the diffuser assembly of claim 1.

12. A cleaning apparatus comprising the electric fan of claim 11.
